(19) United States
(12) Patent Application Publication
(10) Pub. No.: US 2020/0257991 A1
(43) Pub. Date: Aug. 13, 2020

(54) METHODS AND SYSTEMS FOR AUTONOMOUS ENHANCEMENT AND MONITORING OF COLLECTIVE INTELLIGENCE

(71) Applicant: NOOS TECHNOLOGiE INC., Quebec (CA)

(72) Inventors: Sylvie GELINAS, Quebec (CA); Denis POUSSART, Quebec (CA); Clement GENDRON, Sainte-Brigitte-de-Laval (CA)

(21) Appl. No.: 16/649,533

(22) PCT Filed: Sep. 20, 2018
(86) PCT No.: PCT/CA2018/051177

§ 371 Date: Mar. 20, 2020

Related U.S. Application Data
(60) Provisional application No. 62/562,168, filed on Sep. 22, 2017.

(51) Int. Cl. G06N 5/04; G06N 20/00; G06Q 10/06; G06Q 10/10; G06Q 10/04; G06Q 30/02

(52) U.S. Cl. CPC G06N 5/04; G06N 20/00; G06Q 10/0637; G06Q 30/0203; G06Q 10/103; G06Q 10/047; G06Q 10/06311

(57) ABSTRACT

Systems and methods for inducing a transformation in collective intelligence are herein provided. A collective mission and a user group to whom the collective mission applies are defined. User profiles for users of the user group are built, each one of the user profiles defining an engagement level of a given user, the engagement level having a plurality of components. The users are provided with tasks in accordance with a corresponding engagement level, the tasks designed to bring about progression of the users towards the collective mission. User behavior in response to the tasks is monitored and changes in user behavior are detected, the changes indicative of a modification of the engagement level. The user profiles are updated to reflect the modification of the engagement level. The steps of providing users with tasks, monitoring user behavior and detecting changes therein, and updating user profiles may be repeated.

### CROSS-REFERENCE TO RELATED APPLICATIONS

The present application claims priority under 35 USC § 119(e) of provisional patent application bearing Ser. No. 62/562,168, entitled “METHOD AND SYSTEM FOR AUTONOMOUS ENHANCEMENT AND MONITORING OF COLLECTIVE INTELLIGENCE” and filed on Sep. 22, 2017, the contents of which are hereby incorporated by reference.

### TECHNICAL FIELD

The present disclosure relates generally to computer tools and systems for distributing targeted and personalized information and questions to users in order to achieve a common goal, supporting and tracking of the evolution and transformation of users towards the goal through an enhancement of collaborative intelligence, sense-making and decision-making.

### BACKGROUND

Organizations and institutions often wish to disseminate information to large numbers of individuals, for example during a public health crisis or as part of a company culture initiative. Materials with relevant information may be produced in different languages, using a variety of media, and targeting different demographics. Materials providing more basic information and using simpler vocabulary are produced for low-information individuals, and more complex materials are provided for researchers or decision-makers. The goal of information dissemination is often to improve a so-called “collective intelligence” or “collaborative intelligence” regarding a particular issue, to ensure that the individuals as a whole are provided with the necessary information to act appropriately, in synergy, and in line with the guidelines laid out by the organization or institution.

Most existing approaches to information dissemination follow antiquated broadcast models which favour the wide distribution of materials of nominal appropriateness for the eventual audience, with more detailed materials made available via specialized resources. These approaches not only tend to be exceptionally costly, but also typically fail to present individuals with the materials most relevant to their particular situation and existing level of understanding, and lack potential for feedback collection. In addition, these approaches also fail to integrate individual contextualized information that is relevant for providing a broad solution. This, in turn, means that the collective mission is unlikely to be fully achieved.

Therefore, there is room for approaches to collaborative intelligence to be enhanced by using autonomous and intelligent tools.

### SUMMARY

In accordance with a broad aspect, there is provided a computer-implemented method, comprising: (a) defining a collective mission and a user group to whom the collective mission applies; (b) building user profiles for users of the user group, each one of the user profiles defining an engagement level of a given user, the engagement level having a plurality of components; (c) providing the users with tasks in accordance with a corresponding engagement level, with the tasks being designed to bring about progression of the users towards the collective mission; (d) monitoring user behavior in response to the tasks and detecting changes in user behavior, with the changes being indicative of a modification in the engagement level; (e) updating the user profiles to reflect the change in the engagement level; and (f) repeating (c), (d), and (e).

In some embodiments, the plurality of components comprise a thinking component, an action component, and a knowledge component, the thinking component corresponding to a level of analysis of the user, the action component corresponding to a level of interaction of the user within the organization, and the knowledge component corresponding to a level of knowledge of the user with regards to the collective mission.

In some embodiments, the plurality of components each have n levels associated thereto, and the engagement level of each user is mapped in a three dimensional space along a thinking component axis, an action component axis, and a knowledge component axis.

In some embodiments, the method further comprises mapping the collective mission in the three-dimensional space, measuring a distance between the users and the collective mission, and estimating an individually optimized path for inducing the progression of each user towards the collective mission.

In some embodiments, providing the users with tasks comprises using information-push mechanisms to steer information to the users and using information-pull mechanisms to solicit feedback from the users.

In some embodiments, materials used for the information-push and information-pull mechanisms are stored and retrieved from a semantic database that is updated regularly, and the materials are individually tagged.

In some embodiments, the semantic database is initialized by at least one of subject-matter experts and users, and then moves into an autonomous, self-learning-mode of updating.

In some embodiments, the materials are mapped in the three-dimensional space and distances between the users and the materials are used to select which materials are used for the information-push and information-pull mechanisms.

In some embodiments, building user profiles comprises building a group user profile, and wherein updating the user profiles comprises updating the group user profile to reflect the change in engagement level of the group.

In some embodiments, the change in the engagement level is measured as any one of a change in a frequency of contribution, a change in a frequency of consumption of information, a change in a complexity level of contribution, a change in a complexity level of information consumed, a change in a frequency of interaction, and a change in a level of interaction.

In accordance with another broad aspect, there is provided a system, comprising: a processing unit; and a non-transitory computer-readable memory communicatively coupled to the processing unit and comprising computer-readable program instructions. The computer-readable program instructions are executable by the processing unit for: (a) defining a collective mission and a user group to whom the collective mission applies; (b) building user profiles for users of the user group, each one of the user profiles defining an engagement level of a given user, the engagement level having a plurality of components; (c) providing the users with tasks in accordance with a corresponding engagement level, the tasks designed to bring about progression of the users towards the collective mission; (d) monitoring user behavior in response to the tasks and detecting changes in user behavior, the changes indicative of a change in the engagement level; (e) updating the user profiles to reflect the change in the engagement level; and (f) repeating (c), (d), and (e).

In some embodiments, the plurality of components comprise a thinking component, an action component, and a knowledge component, the thinking component corresponding to a level of analysis of the user, the action component corresponding to a level of interaction of the user within the organization, and the knowledge component corresponding to a level of knowledge of the user with regards to the collective mission.

In some embodiments, the plurality of components each have n levels associated thereto, and the engagement level of each user is mapped in a three dimensional space along a thinking component axis, an action component axis, and a knowledge component axis.

In some embodiments, the program instructions are further executable for mapping the collective mission in the three-dimensional space, measuring a distance between the users and the collective mission, and determining an optimal path for inducing the progression of the users towards the collective mission.

In some embodiments, providing the users with tasks comprises using information-push mechanisms to steer information to the users and using information-pull mechanisms to solicit feedback from the users.

In some embodiments, materials used for the information-push and information-pull mechanisms are stored and retrieved from a semantic database that is updated regularly, and the materials are individually tagged.

In some embodiments, the semantic database is initialized by at least one of subject-matter experts and users, and then moves into an autonomous mode for updating.

In some embodiments, the materials are mapped in the three-dimensional space and distances between the users and the materials are used to select which materials are used for the information-push and information-pull mechanisms.

In some embodiments, building user profiles comprises building a group user profile, and wherein updating the user profiles comprises updating the group user profile to reflect the change in engagement level of the group.

In some embodiments, the change in the engagement level is measured as any one of a change in a frequency of contribution, a change in a frequency of consumption of information, a change in a complexity level of contribution, a change in a complexity level of information consumed, a change in a frequency of interaction, and a change in a level of interaction.

### BRIEF DESCRIPTION OF THE DRAWINGS

The invention will be described in greater detail with reference to the accompanying drawings, in which:

FIG. 1 is a flowchart illustrating an embodiment of a method for inducing a transformation in collective intelligence;

FIGS. 2A-D are example three-dimensional engagement-level plots;

FIG. 3 is an example three-dimensional group engagement-level plot;

FIG. 4 is a schematic diagram of an example user profile in accordance with an embodiment;

FIG. 5 is a schematic diagram of an example semantic database in accordance with an embodiment;

FIG. 6 is a block diagram illustrating an embodiment of a computing system for implementing the method of FIG. 1 in accordance with an embodiment; and

FIG. 7 is a block diagram illustrating an embodiment of a collective intelligence system.

### DETAILED DESCRIPTION

Even when belonging to a common organization and having a collective mission to achieve, individuals have different levels of interests, needs, preferences, and roles within their organization, and therefore act differently and wish to offer different contributions toward achieving the collective mission. It is therefore incumbent on organizations to share with each individual the most appropriate information for them at the most appropriate time. In order to select the appropriate information to share with an individual, and the appropriate time at which to share the information, the particular engagement level of each individual with respect to the collective mission, and how this engagement level relates to the various materials that the organization has available, is used by the system described herein.

In this context, the organization may be a company, a firm, an enterprise, a non-profit organization, a government, a public health or public interest institution, a think tank, a media, a network, a group of persons or citizens, formally organized or otherwise, and the like. For example, a company performs dissemination of materials to improve the collective intelligence of its employees with respect to environmental issues and waste reduction within the company. In another example, a government or public health institution disseminates information regarding the risks of a particular disease outbreak to prevent the spread thereof. Any such organization may consider disseminating information with the goal of inducing a transformation in collective intelligence of a relevant group of individuals. It should be noted that “collective intelligence” may take on a variety of meanings. For example, collective intelligence may refer to the continuous and systemized inputs coming from collaborative intellectual efforts to identify, share, analyze, evaluate, document, and other behaviors that allows for knowledge transmission, development, and emergence, providing a growing multi-perspective view that leads to a new level of understanding and new level of capacity for individual and group sense-making and decision-making. Other suitable quantifications of the presence of knowledge within the group of individuals are also considered.

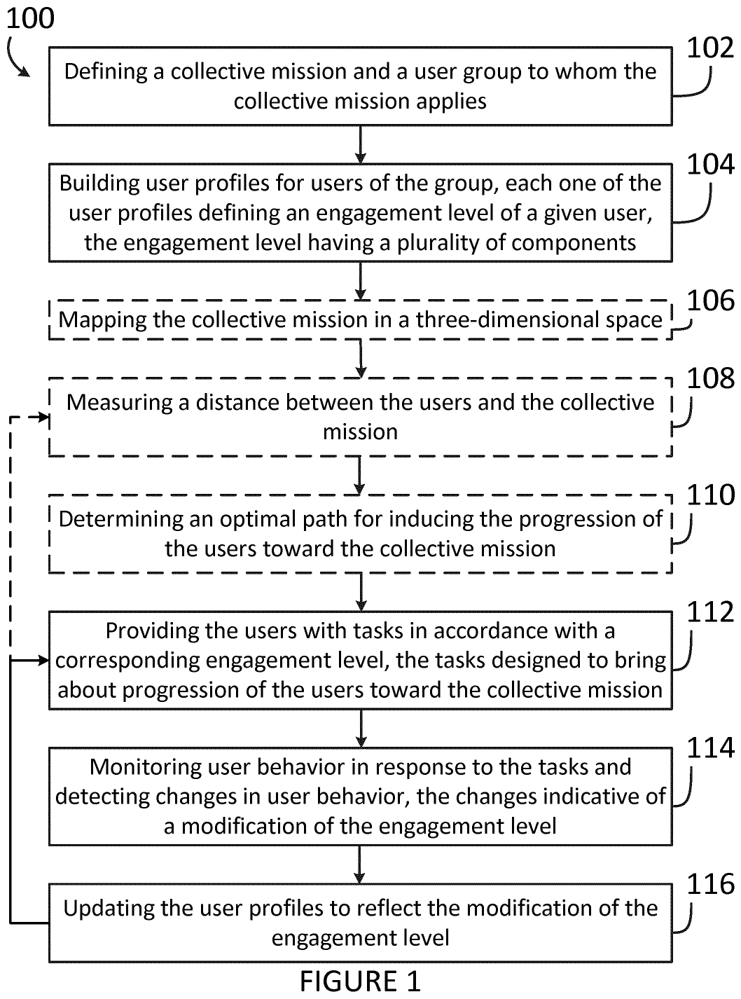

With reference to FIG. 1, a method 100 for operating a tool or system for inducing a transformation in collective intelligence of a relevant group of individuals is illustrated. At step 102, a collective mission, and a user group to whom the collective mission applies, are defined. The collective mission is any suitable goal or objective toward which the users of the user group will collectively work. The user group can be any suitable group of individuals, and may include any suitable number of users. For example, the collective mission is a better understanding of the importance of waste reduction within a company, or a particular quantifiable waste reduction goal, and the user group is the employees of the company. In another example, the collective mission is improved collective intelligence regarding various procedures to reduce a risk of disease infection, or a quantifiable reduction in a rate of transmission of a disease, and the user group is a group of public health officials and professionals tasked with addressing the disease.

At step 104, individual user profiles are built for each of the users in the user group. The user profiles may include any suitable information relating to their respective user. In some embodiments, the user profiles have one or more identifiers which link each of the user profiles to their respective user. In some further embodiments, the user profiles include information relating to preferences of their respective user. In some additional embodiments, each of the user profiles includes transaction history to track actions made by the user within the context of progressing toward the collective mission.

The user profiles also store information relating to an engagement level of their respective users. The engagement level is a numerical or other quantifiable indicator of the engagement of the user with respect to the collective mission. The engagement level is composed of a plurality of components, which are used to quantify different aspects of the engagement level of the user. In some embodiments, three components are used. In other embodiments, more or fewer components are used, and these components may refer to any suitable indicators of the engagement level of the user. For example, the three components of the engagement level include a “thinking” component, an “action” component, and a “knowledge” component.

The thinking component is representative of the thinking process of the user. In some embodiments, the thinking component uses indicators aligned with four levels of a generic critical and creative thinking process for which individuals may have different preferences, level of uses, and global or partial use. In some embodiments, the four levels are clarification, ideation, development, and planning for implementation, each level having specific system-trackable systemic loops and characteristics such as sources, content, format, zones, user behaviors, and responses that are classifiable within one or more of the four levels. The clarification level relates to gaps and goal identification, data gathering on goal- and context-inclusive (of all types of information, from personal comment to meta studies), problem and sub-problems statements, data gathering on information qualities characteristics (such as source credibility level), and multi-perspectives (user and groups of users) evaluation. The ideation level relates to new-potential-option identification related to problem or sub-problems, data gathering on options, data gathering related to evaluation of option qualities and characteristics (such as level of originality and level of estimated added value), and multi-perspectives (user and groups of users) evaluation. The development level relates to adaptation to context of selected option-increasing estimated levels of feasibility, benefits, and the like, and multi-perspectives (users and groups of users) evaluation. The planning for implementation level relates to data gathering on steps, actions and other planning related data and multi-perspectives (users and groups of users) evaluation.

The action component is indicative of the organizational responses of the user. In some embodiments, the action component uses indicators aligned with contextual structures and/or hierarchies of organization, for which individuals may have different roles, positions, levels of responsibility, and interactions with others, with different behaviors, frequency of uses, level of complexity, preferences and other data related to their position within an organization. In some embodiments, the action item is provided with four levels, informational, tactical, strategic, projective, and each has specific system-trackable loops and characteristics such as sources, content, format, zones, user behaviors, and responses that are classifiable within one or more of the four levels. The informational level is associated with services and activities of support. The tactical level is associated with technical and practical elements. The strategic level is associated with planning and managing. The projective level is associated with planning for the future and high-level strategy.

The knowledge component is indicative of the amount of learning the user has accomplished with respect to the collective mission. In some embodiments, the knowledge component uses indicators aligned with change-management phases and levels of knowledge, including learning-interest levels in relation to the collective mission, which may vary on an individual basis due to different backgrounds (such as education level, domain of expertise, experience, etc.), different behaviors, frequency of uses, level-of-complexity preferences, and other data. In some embodiments, the knowledge component is provided with four levels, novice, reactive, active, leader, and each has specific system-trackable loops and characteristics such as sources, content, format, zones, user behaviors, and responses that are classifiable within one or more of the four levels. The novice level is associated with little-to-no awareness of a topic, no recognition of the importance of a topic, and no or very low probability of engagement in relation to the topic. The reactive level is associated with a low awareness level regarding the topic, a low recognition level of topic importance, and low probability of engagement in relation to the topic. The active level is associated with intermediary awareness of a topic, intermediary recognition of the importance of a topic, and intermediary probability of engagement in relation to the topic. The leader level is associated with a high awareness level regarding the topic, a high recognition level of topic importance, and high probability of engagement in relation to the topic.

In some embodiments, the components also include null-value levels for each component, which may be represented as a “don't care” level which is added to the four levels of each of the above-listed components.

Collectively, the thinking, knowledge, and action components of the engagement level are referred to as “TAK”: a user may have an engagement level mapped in a TAK space, which is a three-dimensional space with thinking, action, and knowledge axes. In some embodiments, the engagement level of the user is expressed as a numerical value. In some other embodiments, the engagement level of the user is expressed as a collection of tags or other non-numerical values. Additionally, in some embodiments, each of the different levels within each of the components is also a variable value: for instance, with regards to the “thinking” component, a user may have a high value of “clarification”, a medium value of “ideation”, a low level of “development”, and a null value of “planning”, each along the thinking axis. In this case, the engagement level of the user is expressed as a tensor rather than as a vector or a point. It should be noted that in other embodiments, other components are considered, which may have different levels, and may be mapped in other multi-dimensional spaces.

In some embodiments, the user profiles store the engagement level of the users as a mapping or a position in the TAK space. For example, upon building the user profile for a particular user, the user is assigned a default engagement level based on one or more parameters of the user, for instance their role, their education level, and the like. The default position of a particular user may be expressed numerically, for example (2,1,2), corresponding to “ideation” on the thinking axis, “tactical” on the action axis, and “novice” on the knowledge axis, or in any other suitable way.

Optionally at step 106, the collective mission is mapped in a three-dimensional space, for instance using the TAK space. The collective mission is mapped to establish a position or region at which the collective mission is located along the components of the engagement level. In some embodiments, the collective mission is a point at a particular position, and in other embodiments the collective mission is expressed as a tensor occupying a particular region. For example, the collective mission is mapped or concentrated in the TAK space at “development” along the thinking axis, “strategic” along the action vector axis, and “leader” along the knowledge axis, and is represented numerically as (3,4,3). When other spaces are used, the collective mission is mapped using different components of the engagement level, and in any suitable multi-dimensional space.

Optionally, at step 108, a distance between the users of the user group and the collective mission is measured. In some embodiments, the positions of the users and the collective mission are mapped in a multidimensional space, for example the TAK space. The distance between a user positioned at (2,1,2) and a collective mission at (3,4,3), as in the above examples, can be determined using any suitable mathematical techniques. Since the users of the user group may be located at different positions in the TAK space, based on their respective user profiles, the distance between each user and the collective mission varies. In some embodiments, the user profiles are updated to include the distance between the users and the collective mission.

Optionally, at step 110, an optimal path for inducing the progression of the users toward the collective mission (from their original positions) is determined. In some embodiments, the optimal path is considered a most direct path between the position of the user and the collective mission. In other embodiments, an optimal path is determined based on other relevant information present in the user profile of the user, and the optimal path is not necessarily a most direct path.

At step 112, the users are provided with tasks, in accordance with a corresponding task engagement level, which are designed to bring about progression of the users toward the collective mission. In some embodiments, the tasks include reading or viewing one or more materials which attempt to increase or improve the engagement level of the user. In other embodiments, the tasks include sharing one or more materials with other users. In still further embodiments, the tasks include completing one or more learning modules which attempt to increase or improve the engagement level of the user. Still other types of tasks are considered, such as completing surveys or questionnaires. In some embodiments, the user profile of the user is updated upon being assigned a task, irrespective of the response of the user to the task.

Each of the tasks has a corresponding task engagement level which is indicative of a quantifiable degree of engagement in the collective mission expressed or displayed in the task. By completing a particular task having a given task engagement level, users indicate that their own user engagement level is aligned with, or approaching, the task engagement level of the task with which they were provided.

The task engagement level is expressed using the same methodology as the engagement levels of the users. In embodiments where the engagement level of the users is expressed as a position with the TAK space, the task engagement level of each task is also expressed as a position within the TAK space. By using a common evaluation system for users and tasks, each of the tasks can be compared against the position of the users to determine whether a particular task is appropriate for a particular user, as a function of the engagement level of the user.

At step 114, user behavior in response to the tasks is monitored, and changes in user behavior are detected, which are indicative of a change in the engagement level of the user. When provided with a particular task, a user may complete the task, may partially complete the task, or may fail to complete the task. Depending on the nature of the task, the user behavior in response to being provided with the task is indicative of the user's acceptance of the task, and of the task engagement level associated therewith. By monitoring the behavior of the user, and changes therein, it is possible to detect changes in the engagement level of the user. Monitoring user behavior includes collecting feedback from the user in one or more forms. In some embodiments, feedback is passively collected by monitoring the actions taken by the user, for example via a computing device or other tool used by the user. In other embodiments, active feedback is solicited from the user via questionnaires, surveys, contributions, and the like.

For example, a given user is provided with a task having a task engagement level that is beyond the engagement level of the given user. If the user completes the task, or otherwise exhibits positive behavior in response to the task, this is indicative of the user's engagement level progressing toward the collective mission along one or more components of the engagement level. For instance, a user having a thinking component of “clarification” responding favourably to a task having a task engagement level of “ideation” indicates that the engagement level of the user is progressing along the thinking axis. In another example, the given user is provided with a task having a task engagement level that is equivalent to the engagement level of the given user. If the user fails to complete the task, or otherwise exhibits negative behavior in response to the task, this is indicative of the user's engagement level regressing away from the collective mission in one or more ways. In some embodiments, the change in engagement level is measured in terms of changes in the user's frequency or level of contributions, of consumption of information, and/or of interaction.

In some embodiments, the particular feedback solicited from the user is selected on the basis of an engagement level associated with the particular feedback. For example, a user having a low engagement level is more likely to respond to feedback which is associated with a lower engagement level, for instance a simple radio button questionnaire or a small number of ‘Yes’/No′ questions. In another example, a user having a higher engagement level is solicited to produce a written document explaining the tasks which was assigned to them and how they went about completing it.

Other types of feedback are also considered, including, but not limited to: ignoring the task, commenting on the task, evaluating the task, producing a synthesis of the task or of a material related thereto, forwarding a material related to the task to other users, following other users, pinning a task or a material related thereto to a personal page or public page, linking and/or ranking the information provided via the task, for example in relation to other tasks and/or materials, threading tasks and/or materials related thereto, answering questionnaires, surveys, quizzes, and the like, defining an information status of the task or a material related thereto as relevant for decision-making, and searching for additional information relating to the task or a material related thereto.

At step 116, the user profile is updated to reflect the change in the engagement level of the user as determined at step 114. The engagement level of the user as present in the user profile may be adjusted in any suitable way based on the changes in engagement level. In some embodiments, a previous engagement level of the user is replaced based on changes in the engagement level determined at step 114. In other embodiments, the engagement level of the user is an aggregate based on a history of changes in the engagement level and/or based on a history of monitored user behavior.

At this point, the method 100 can return to step 112 and provide the user with one or more additional tasks, or optionally to step 108 to measure a subsequent distance between the users and the collective mission. The method 100, as particularly illustrated in the repetition of steps 112 and 114, operates using a push-pull methodology, in which tasks are pushed to the user (step 112) and feedback is pulled from the user (step 114) in the form of monitored user behavior. This helps progress the user toward the collective mission through repeated opportunities to increase their engagement level and repeated evaluation of the user's response to the tasks provided, and also provides a quantitative measure of each user's progression towards the collective mission.

Because the method 100 can be implemented in a substantially automated fashion, the method 100 can be used to autonomously accelerate progress of the user group toward the collective mission by repeatedly providing users with tasks which bring about progression of the users toward the collective mission. In addition, monitoring of the responses of the users to the tasks can provide a self-learning behaviour to the system, such that the system gradually progresses over time. In some embodiments, the method 100 fosters the emergence of collective intelligence—at the organisational level—as synergy between the sense-making and decision-making capabilities of each user builds up through advanced dialogue and information sharing, for example when users perform tasks which relate to sharing or discussing particular materials with other users. The sharing concept includes actions such as dispatching, analysing, developing and creating or any other action made to support information relevance.

In addition, because the same TAK space (or other common space based on common components of the engagement levels) is used to quantify the engagement level for each of users, tasks, feedback, and the collective mission, interaction dynamics between these four elements may be estimated in coherent and consistent fashion, even though the four elements are of distinct nature. The common space for quantifying the users, tasks, feedback, and the collective mission also means that the “distance” between any two (or more) such elements is computable and usable to best estimate how a user will react to a particular task, how two users will interact with one-another, and how to best steer the user group toward the collective mission using the push-pull methodology of the method 100.

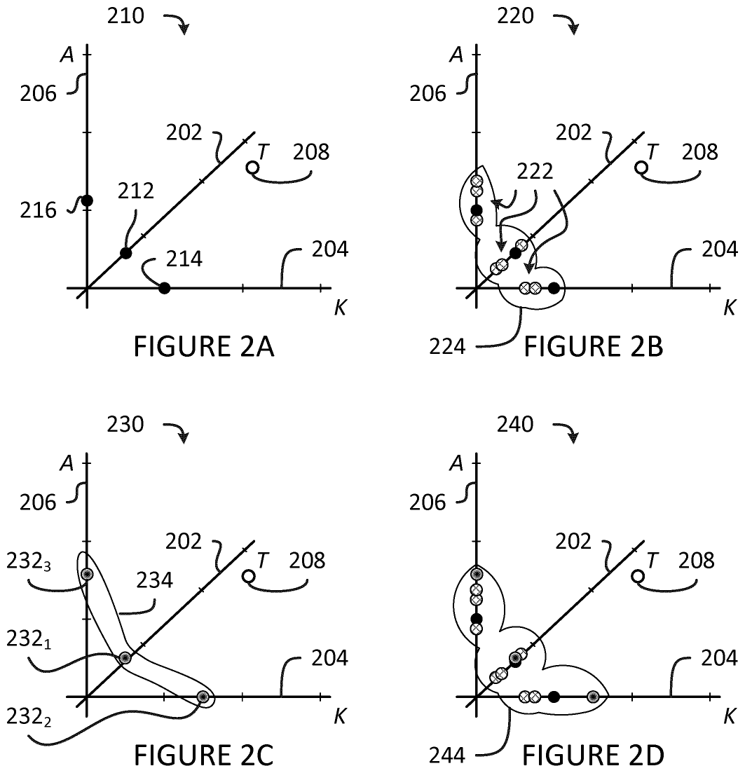

With reference to FIGS. 2A to 2D, there are shown multiple three-dimensional mappings of the engagement level for a particular user along TAK axes 202, 204, 206. In addition, the position of the collective mission 208 is illustrated as a point in the three-dimensional mapping. In FIG. 2A, a base engagement level 210 is illustrated as a collection of points 212, 214, 216 along the TAK axes. For example, the base engagement level 210 may be the default engagement level for the particular user which is instantiated when the user profile is built at step 104. In some embodiments, the base engagement level 210 is based on one or more parameters of the user. In this example, point 212 illustrates that the user is placed between the “clarification” level and the “ideation” level along the thinking axis 202, point 214 illustrates that the user is placed at the “reactive” level along the knowledge axis 204, and point 216 illustrates that the user is placed above the “tactical” level along the action axis 206. The points 212, 214, 216 are thus indicative of the base positioning of the engagement level of the user at some original time at which the user profiles are created.

In FIG. 2B, a second engagement level 220 is illustrated, which includes additional points 222 which have a hatched fill. As the method 100 is executed, the user is repeatedly provided with tasks, and the behavior of the user is monitored for changes in the engagement level of the user. The additional points 222 are indicative of the user behavior in response to the tasks provided to the user, and the engagement level 220 indicates the engagement level of the user at some time following the building of the base engagement level 210.

In some embodiments, in order to validate the base engagement level 210, the tasks with which the user is provided have a task engagement level which is very close to the base engagement level 210 of the user. Depending on the response of the user to the tasks, the engagement level 220 of the user is adjusted. In this example, the engagement level 220 of the user is an aggregate based on the history of the engagement levels of the user. In other examples, the engagement level of the user is based only on a limited number of recent monitored user behaviors and/or engagement level changes. Additionally, the overall engagement level 220 of the user can be illustrated by a cloud 224, which is indicative of patterns in the engagement level of the user and represents the likely set of choices and behaviours of the user.

In some embodiments, the method 100, and in particular steps 112 to 116 (optionally including steps 108 and 110) are repeated a predetermined number of times to validate the base engagement level 210 and to obtain the engagement level 220. In other embodiments, the method 100 is immediately executed with the assumption that the base engagement level 210 is accurate.

In FIG. 2C, a task engagement level 230 for a particular task is illustrated via points 232₁, 232₂, 232₃ on the T, K, and A axes, respectively, which are illustrated with a gradient, and cloud 234. At some point in the method 100, a task is provided to the user, as per step 112, which is designed to bring about progression of the user toward the collective mission 208. The particular task shown in FIG. 2C is located closer to the collective mission than the engagement level 220 of the user shown in FIG. 2B. In this example, the position of the particular task along the thinking axis, illustrated by point 232₁, is approximately in the same position as the user's engagement level on the thinking axis, and the positions of the particular task along the knowledge and action axes, illustrated by points 232₂ and 232₃, are closer to the collective mission 208 than the engagement level 220 of the user.

In FIG. 2D, if the user given the particular task illustrated in FIG. 2C exhibits positive behaviour in response to the task, a change in the engagement level of the user is detected and the engagement level of the user is updated to the engagement level 240. In this example, the engagement level of the user is updated to include the task engagement level of the particular task shown in FIG. 2C, and an updated cloud 244 for the engagement level 240 of the user is illustrated. In this fashion, the method 100 can be used to repeatedly provide the user with subsequent tasks which further the progress of the user toward the collective mission 208, and based on the user's behavior, the engagement level of the user is repeatedly updated to track their progress toward the collective mission 208.

In some embodiments, the progress of the engagement level of the user toward the collective mission 208 is tracked on the basis of one or more variables associated with each of the TAK components. For instance, the base engagement level indicates that certain variables of the “thinking” component are initially assumed to be “attractive” and others “repulsive”. After the engagement level of the user is validated, illustrated as engagement level 220, certain variables are determined as being personally attractive or personally repulsive to the user. Further iterations of the push-pull methodology may reinforce variables as having “stabilized attractiveness” or “stabilized repulsiveness”. Particular variables which indicate stabilized attractiveness may in turn be flagged as having potential for progressing the engagement level of the user with respect to the particular variables, which are referred to as having “personal progression potential”. Further reinforcement of variables having personal progression potential leads to those variables as being marked as “personally progressive” once the engagement level of the user progresses toward the collective mission with respect to the personal progression potential variable. At each stage of the progression of the engagement level of the user with respect to each variable, the tasks assigned to the user and the feedback solicited form the user is further narrowed on the basis of the characteristics of the variables. In some embodiments, once a variable of a user reaches the personally progressive level, the particular tasks presented to the user in relation with the progression of the variable are indicated as having organizational potential for progressing other users in the same fashion.

In some embodiments, after a particular user is provided with a given task and feedback relating to that task is collected, the adjustment of the TAK of the user (performed on the basis of the feedback of the user) is based on one or more variables being attractive or repulsive. A variable being determined as attractive will cause the engagement level of the user to be moved toward the collective mission in the TAK space in line with the variable in question. Similarly, a variable being determined as repulsive will cause the engagement level of the user to be moved away from the collective mission in the TAK space in line with the variable in question.

Based on the new engagement level of the user, and their response to various variables as being attractive or repulsive, new tasks are provided to the user and new feedback is solicited therefrom, to further move the engagement level of the user toward the collective mission. For example, the new tasks and new feedback mechanisms are selected based on the variables which are marked as “attractive”, “stabilized attractiveness”, “personal progression potential”, and/or “personally progressive”. The progression of certain variables from “attractive” to “personally progressive” may allow the selection of tasks and feedback mechanisms which are most likely to progress the user from their current engagement level toward the collective mission. This process may be repeated for all users of the user group in a substantially parallel process.

In addition, in the event that a particular user responds to a particular task with feedback that is substantially beyond what would be expected for a particular user, a validation process for the new engagement level of the user may be performed. For example, the feedback provided by the user is of a much higher complexity than the usual feedback provided by the user. Further tasks are provided to the user based on the most attractive variables for the user to elicit additional feedback, and to progress the engagement level of the user toward the collective mission. New tasks are automatically and adaptively selected and steered to each user by a process that is driven by the parameters described above. The selection process may be implemented by a variety of mechanisms, for example using lookup tables, nested or hierarchical if-then-else evaluations, and the like.

In some embodiments, tasks are provided to a given user at particular moments in time, for instance at moments that are deemed to reduce disruption for the user, or which are appropriate in any other way. For instance, a user can provide an indication of their normal responsibility schedule, and the system can select moments in time which minimize conflict with the user's normal responsibility schedule. In another instance, the user can provide an indication of one or more preferred moments for task presentation, and the system can provide tasks accordingly. Other embodiments are also considered.

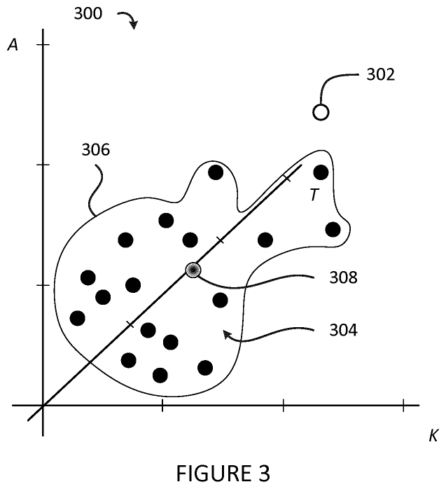

With reference to FIG. 3, in a similar fashion, the collective mission 302 and the engagement levels 304 of all the users of the user group can be illustrated using a group engagement level 300 made of individual points in a three-dimensional TAK space. The group engagement level 300 is an aggregate of the engagement level of each of the users, illustrated as a collection of points in the TAK space, and each coordinate of each point is indicative of the location of the respective user's engagement level along the thinking, action, and knowledge axes. Additionally, a cloud 306 can be drawn to illustrate the overall location of the engagement level of the user group. As the method 100 is executed and repeated, the progression of the group engagement level 300 toward the collective mission 302 can be visualized via movement of the cloud 306. In some embodiments, an average group engagement level 308 is illustrated as a point having a visual characteristic different with respect to the engagement levels 304 of the users. In some embodiments, instead of an average, a median, mode, or other statistically significant value is illustrated in the group engagement level 300.

The group engagement level 300 is a function of the individual engagement levels of the users which compose the user group. Therefore, in order to progress toward the collective mission 302, it may be helpful to identify, recognize, and induce progress in the engagement levels of the users on an individual basis. For the members of the organization pushing for progress toward the collective mission, it may be helpful to be aware of individual competencies, interests, etc., of each user with respect to the collective mission, and understand their complementarities and differences. Implementation of the method 100 may support the process of self-organization from which collective intelligence and sense-making emerge when a variety of resources work in synergy.

In some embodiments, the group engagement level 300 is used to identify subgroups within the user group which share common interests or strengths, based on their respective engagement levels and/or based on converging feedback patterns to common tasks. For example, a subgroup of users which have a high engagement level component on the “thinking” axis are identified, and provided with particular tasks to shore up weaknesses in other engagement level components. For instance, the users of the subgroup are provided with collaborative tasks which pair subgroup users having a weak “action” engagement level component with subgroup users having a weak “knowledge” engagement level component. In another example, a subgroup of users is provided with a task of forming a discussion forum for sharing particular materials or issues.

It should be noted that although FIG. 3 is used to illustrate a TAK space for the user group as a whole, a similar TAK space can be produced to illustrate the different types of feedback which are available to solicit from users, or to illustrate the different types of tasks which are available for proposal to users. A feedback TAK space can help the organization target types of feedback which are underserved; similarly, a tasks TAK space can help the organization target types of tasks which are lacking. Additionally, the group engagement level 300, or the cloud 306 associated therewith, can be overlaid with the feedback TAK space and/or the tasks TAK space to better identify issues with the tasks and/or feedback mechanisms in place. In addition, as additional information is obtained about the different tasks and feedback mechanisms, the position in the TAK space of the tasks, feedback mechanisms, and the like, may also be adjusted, for example based on the responses of users to the tasks and feedback mechanisms. Re-evaluating the position in the TAK space of the tasks and feedback mechanisms, as well as the users and the user group as a whole (on the basis of their respective engagement levels) can be used to develop new patterns for moving users, and the user group as a whole, toward the collective mission.

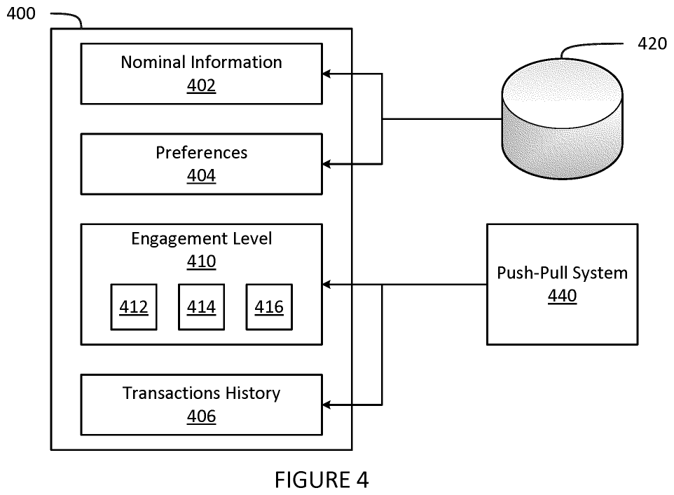

With reference to FIG. 4, there is shown an example user profile 400. The user profile 400 includes nominal information 402, preferences 404, a transactions history 406, and an engagement level 410. The nominal information 402 includes one or more identifiers of the user to which the user profile 400 is associated, and other information about the user, for example a role within the organization, a level of education, one or more psychometric values, and the like. The preferences 404 include information relating to preferred media types or preferred media presentation timings for the user. Both the nominal information 402 and the preferences 404 are populated via a database 420 or other suitable repository. In some embodiments, the nominal information 402 and/or the preferences 404 are updated on a regular or punctual basis, for example when changes are made to the database 420.

The transactions history 406 stores a record of various tasks provided to the user and any feedback obtained from the user. In some embodiments, the transactions history 406 stores timestamps or other identifying information regarding the tasks and/or feedback. In other embodiments, the transactions history 406 stores organization-wide assessment information of various other indicators, for example statistics on shared information, potential patterns for most efficient information evaluation, level of activity by division, real time update on interests, and potential needs of information by hierarchal levels, etc. Put differently, the transaction history 406 includes information which can be used to track the activity of the user vis-à-vis the various tasks provided to the user, in relation to the user group as a whole or to subsets thereof, the relationships between tasks and changes in the engagement level 410 of the user, and the like.

In addition, the user profile 400 stores the engagement level 410, which has a plurality of components. In some embodiments, including the embodiment shown in FIG. 4, the engagement level 410 has three components 412, 414, and 416, each of which is associated with one of the TAK axes. Both the transactions history 406 and the engagement level 410 are configured for being updated by a larger or overarching system, for example the push-pull system 440 shown in FIG. 4, in response to receipt of user feedback and/or changes in the engagement level of the user.

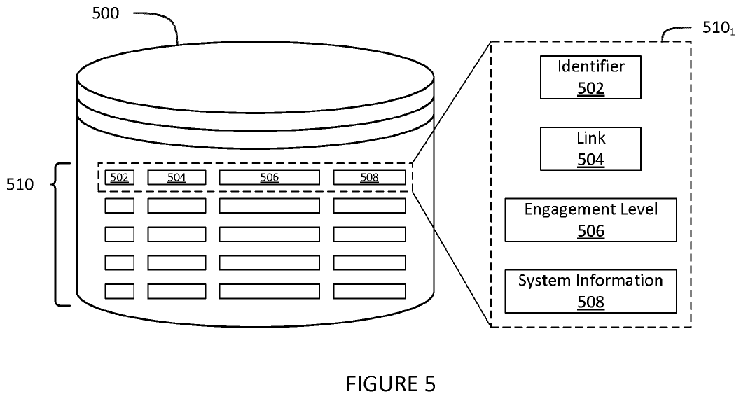

With reference to FIG. 5, the various materials containing information which are presented to the users as part of the tasks they are provided are stored in a semantic database (SDB) 500. The SDB 500 is structured as a large linked list of entries 510, each describing a specific material (a text document, graphics, presentations, video, audio recording etc.) of relevance to the collective mission. In some embodiments, the SDB 500 stores the materials therein; in other embodiments, the SDB 500 stores links or pointers to the materials, which are located at some remote location. In some other embodiments, the SDB 500 stores some materials and links to some others, as appropriate. The materials stored and/or linked to in the SDB 500 are information objects that are retrieved either from external sources, such as public web spaces or other public network locations, or from internal, organization-proprietary data repositories.

Each of the entries 510 includes a plurality of fields. In some embodiments, an example entry 510₁ includes an identifier field 502, a link field 504, an engagement level field 506, and a system information field 508. The identifier field 502 stores an identification number or other identifier for the document, which may be a unique identifier or a semi-unique identifier, as appropriate. In some embodiments, the identifier field 502 also includes raw source data and/or a summary of the document. The link field 504 stores an address for retrieval of the material, which may be a URL or URI, or any other suitable address, and optionally search parameters which were used to locate the material and/or a timestamp of the material retrieval. The engagement level field 506 includes an engagement level for the material, for example in the TAK space. The system information field 508 stores metadata, for example a list of users to whom the material was provided and associated timestamps, or any other suitable metadata.

In some embodiments, a manual population of the SDB 500 is performed when initializing the SDB 500. For example, one or more persons who are subject-matter experts (SMEs) with respect to the collective mission are tasked with identifying materials which are relevant to progressing the user group toward the collective mission, and with formulating feedback mechanisms. Additionally, the SMEs are tasked with assigning the engagement level 506 to the various materials based on their evaluation of the various components of the engagement level exhibited by the materials. For example, the SMEs assign values along the three TAK axes to each of the materials. In some embodiments, the tasks are first placed in one or more temporary databases, and are later validated when confirmed by at least one second SME. In other embodiments, the SDB 500 can be populated based on inputs received from one or more users of the system. Still other approaches for populating the SDB 500 are considered.

In some embodiments, the SMEs assign keyword search patterns to each of the documents, which are thereafter used by a search engine for the identification of materials. In some embodiments, the results of the SMEs-assigned engagement levels and/or keyword search patterns are validated by comparing the engagement levels and/or keyword search patterns of multiple SMEs. Once the values in the SDB 500 are sufficiently refined the SDB 500 can operate autonomously, without input from the SMEs. It should be noted that in some other embodiments, the SDB 500 is configured for autonomously self-populating, for example via one or more semantic processing systems

Once the SDB 500 is operating autonomously, the SDB 500 can perform various self-improvement processes to further refine the engagement levels and/or keyword search patterns for the various materials provided by the SDB 500. These processes can include generating additional keyword search patterns for example based on user-driven search-and-retrieval validation activity, machine-learning-based translation of engagement levels, as expressed in the TAK space, into additional keyword search patterns, extraction of keyword search patterns from selected material entries and their engagement level, and/or updating information-flow sharing. Feedback mechanisms can also be improved using similar techniques. In addition, feedback provided by users via the method 100 can be used to modify the engagement levels of the materials in the SDB 500. The self-improvement processes can occur within the SDB 500 during normal operation, or during particular phases of operation of the SDB 500.

In some embodiments, users are provided with the ability to generate alerts identifying certain tasks or materials related thereto as critical or emergent. The alerts are provided as tasks to all users, or to a relevant subset thereof, for example administrators or other decision-makers. In some embodiments, the collective mission is then adjusted based on the alert. In other embodiments, a secondary collective mission is established, and the user base may be bifurcated into two separate user bases. In some embodiments, a transitional mission is used to navigate from the original mission to the adjusted or the secondary mission, as is the case. The transitional mission provides separate tasks and feedback mechanisms which are specific to the transition from the original collective mission to the adjusted or secondary mission.

In some embodiments, the information stored in the user profiles 400 and/or in the SDB 500 is used to generate one or more reports. For example, a user may be provided with a periodic or punctual personalized report via a user dashboard or other user interface which shares statistics, an estimation of recent progress and performance, and the like. In another example, periodic or punctual high-level reports are generated which track the behavior of the user group as a whole, or of particular subgroups of interest. The high-level reports may include information relating to current trends, performance assessments, suggestions of management practices, a compendium of popular or well-reviewed tasks and materials related thereto, and the like. In some instances, some or all of the information in the reports is posted to a wiki or other shared organizational resource.

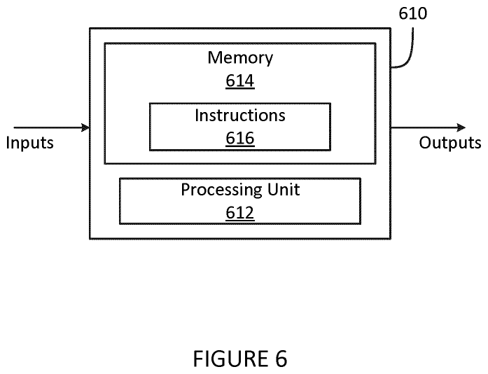

With reference to FIG. 6, the method 100 may be implemented by a computing device 610, comprising a processing unit 612 and a memory 614 which has stored therein computer-executable instructions 616. Embodiments of the computing device 610 include the computing devices 102, 104, and 106 described hereinabove.

The processing unit 612 may comprise any suitable devices configured to implement the method 100 such that instructions 616, when executed by the computing device 610 or other programmable apparatus, may cause the functions/acts/steps of the method 100 described herein to be executed. The processing unit 612 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 614 may comprise any suitable known or other machine-readable storage medium. The memory 614 may comprise non-transitory computer readable storage medium, for example, but not limited to, an electronic, magnetic, optical, electromagnetic, infrared, or semiconductor system, apparatus, or device, or any suitable combination of the foregoing. The memory 614 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 614 may comprise any storage means (e.g., devices) suitable for retrievably storing machine-readable instructions 616 executable by processing unit 612.

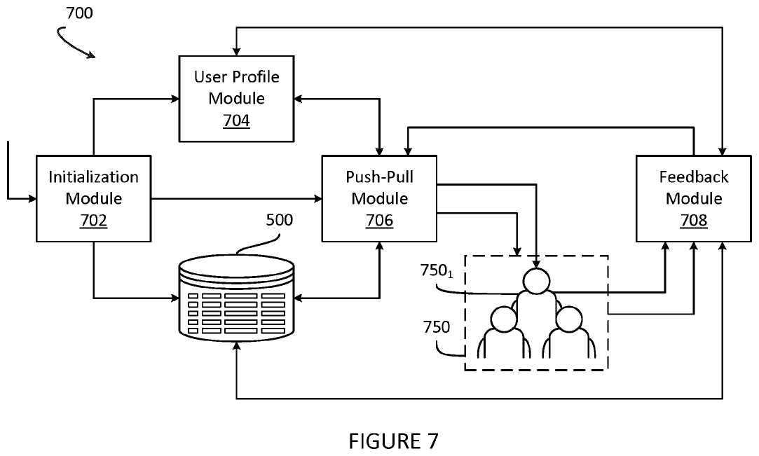

With reference to FIG. 7, there is illustrated an embodiment of a collective intelligence system 700 for inducing a transformation in collective intelligence of a user group 750 composed of a plurality of users, including a user 750₁. The collective intelligence system may be implemented by the computing device 610, or any other suitable computing device, and may be configured for implementing part or all of the method 100. The collective intelligence system 700 includes an initialization module 702, a user profile module 740, the SDB 500, a push-pull module 706, and a feedback module 708.

The initialization module 702 is configured for receiving input from one or more sources for defining a collective mission and a user group to whom the collective mission applies, in accordance with step 102. In some embodiments, the initialization module 702 receives inputs from decision-makers at an organization which indicate the goals or objectives of the collective mission. The initialization module then defines the collective mission in an engagement level space, for example a TAK space. In some embodiments, the initialization module provides the push-pull module 706 with the collective mission, or some representation thereof, for instance the engagement level in the TAK space of the collective mission.

The initialization module 702 is communicatively coupled to the user profile module 704 for causing the user profile module 704 to build user profiles for users of the user group 750, each one of the user profiles defining an engagement level of a given user, the engagement level having a plurality of components, in accordance with step 104. In some embodiments, the initialization module 702 is configured for assigning a base engagement level based on the nominal information 502 and preferences 504 relating to each user. The initialization module is additionally communicatively coupled to the SDB 500, for example for populating the SDB 500, either with the help of SMEs or autonomously, as part of the initialization process for the collective intelligence system 700.

The user profile module 704 is configured for building and maintaining the user profiles. In some embodiments, the user profile module 704 stores the user profiles in a database or other repository. In some embodiments, the user profiles are stored in the SDB 500, or in another storage medium separate from the SDB 500. In some embodiments, the user profile module 704 is also communicatively coupled to the feedback module 708 for receiving information relating to changes in engagement levels of users used in updating the user profiles. The user profile module 704 is communicatively coupled to the push-pull module 706 to provide the push-pull module with information relating to the user profiles, for example the engagement level of one or more users of the user group 750.

The SDB 500 is communicatively coupled to the initialization module 702, for example in order to perform population of the SDB 500, and to the push-pull module 706 for providing information about tasks and materials related thereto to the push-pull module 706. In some embodiments, the SDB 500 is also communicatively coupled to the feedback module 708 for receiving information relating to tasks presented to users, feedback received from users, and the like, for updating one or more fields in the SDB 500.

The push-pull module 706 is communicatively coupled to the user profile module 704 and to the SDB 500 for obtaining information about users' respective engagement levels and about tasks available via the SDB 500. Optionally, the push-pull module 706, or another associated module, is configured for mapping the collective mission as defined by the initialization module in a three-dimensional space, for instance a TAK space, as per step 106. The push-pull module 706 is additionally optionally configured for measuring a distance between the users of the user group 750 and the collective mission, as per step 108. The push-pull module 706 is also optionally configured for determining an optimal path for inducing the progression of the users in the user group 750 toward the collective mission, as per step 110.

The push-pull module 706 is configured for providing users, for example the user 750₁, with one or more tasks in accordance with a corresponding task engagement level, the tasks designed to bring about progression of the user 750₁ towards the collective mission, as per step 112. To this end, the push-pull module 706 is configured for using the information about the engagement level of the user 750₁ and about available tasks to determine an appropriate task for the user 750₁, and an appropriate time to provide the user 750₁ with the appropriate task. In some embodiments, the push-pull module 706 first determines whether it is an appropriate time to present the user 750₁ with a task, and then determines the appropriate task. In other embodiments, the push-pull module 706 first determines whether an appropriate task exists for the user 750₁, and then determines an appropriate time to provide the user with the task. The push-pull module 706 may use one or more search engines to find the appropriate tasks for the user 750₁, and a scheduling system to determine the appropriate time to present the user 750₁ with the task.

In some embodiments, the push-pull module 706 notifies the user 750₁ that a task has been provided to user 750₁. For example, the push-pull module 706 causes an email, a text message, a desktop notification, or any other suitable type of notification to be sent to the user 750₁. The notification may include a task title, a summary of the task, and any other suitable information. In some embodiments, the push-pull module 706 causes the user profile module 704 to update the user profile of the user 750₁ and/or the SDB 500 to update the system information 508 of a relevant entry of the SDB 500 once the user has been provided with the task. It should be noted that the push-pull module 706 is configured for providing any suitable number of tasks to any suitable number of users of the user group 750 in substantially simultaneous fashion. Certain tasks are “broadcast” to the user group 750 as a whole, or to subsets thereof, and other tasks are targeted at individual users, for example the user 750₁.

The feedback module 708 is configured for monitoring user behavior in response to the tasks provided by the push-pull module 706, and for detecting changes in user behavior of the user 750₁, the changes indicative of a change in the engagement level of the user 750₁, in accordance with step 114. In some embodiments, the feedback module 708 is configured for actively soliciting feedback from the user 750₁ via questionnaires, sharing suggestions, and the like. For example, the feedback module 708 is configured for communicating with the user profile module 704 and the semantic database 500 to obtain an appropriate feedback mechanism based on the engagement level of the user 750₁. In other embodiments, the feedback module 708 passively monitors feedback produced by the user 750₁.

The feedback module 708 is additionally configured for causing the user profile module 704 to update the user profile of the user 750₁ to reflect the change in the engagement level of the user 750₁, in accordance with step 116. In some embodiments, the feedback module 708 is configured for communicating substantially directly with the feedback module 708. In other embodiments, the feedback module 708 provides information to the push-pull module 706, which in turn communicates with the user profile module 704 to update the user profile of the user 750₁.

Once the user 750₁ has been presented with a task and their user profile has been updated, the push-pull module 706 can provide the user 750₁ with a subsequent task and the push-pull process repeats, with the aim of progressing the user 750₁ toward the collective mission.

The methods and systems described herein may be implemented in a high level procedural or object-oriented programming or scripting language, or a combination thereof, to communicate with or assist in the operation of a computer system, for example the computing device 610. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or more specifically the processing unit 612 of the computing device 610, to operate in a specific and predefined manner to perform the functions described herein, for example those described in the method 100.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the methods and systems described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A computer-implemented method, comprising:
(a) defining a collective mission and a user group to whom the collective mission applies;
(b) building user profiles for users of the user group, each one of the user profiles defining an engagement level of a given user, the engagement level having a plurality of components;
(c) providing the users with tasks in accordance with a corresponding engagement level, the tasks designed to bring about progression of the users towards the collective mission;
(d) monitoring user behavior in response to the tasks and detecting changes in user behavior, the changes indicative of a modification of the engagement level;
(e) updating the user profiles to reflect the modification of the engagement level; and
(f) repeating (c), (d), and (e).

2. The method of claim 1, wherein the plurality of components comprise a thinking component, an action component, and a knowledge component, the thinking component corresponding to a level of analysis of the user, the action component corresponding to a level of interaction of the user within the organization, and the knowledge component corresponding to a level of knowledge of the user with regards to the collective mission.

3. The method of claim 2, wherein the plurality of components each have n levels associated thereto, and the engagement level of each user is mapped in a three dimensional space along a thinking component axis, an action component axis, and a knowledge component axis.

4. The method of claim 3, further comprising mapping the collective mission in the three-dimensional space, measuring a distance between the users and the collective mission, and determining an optimal path for inducing the progression of the users towards the collective mission.

5. The method of claim 3, wherein providing the users with tasks comprises using information-push mechanisms to steer information to the users and using information-pull mechanisms to solicit feedback from the users.

6. The method of claim 5, wherein materials used for the information-push and information-pull mechanisms are stored and retrieved from a semantic database that is updated regularly, and the materials are individually tagged.

7. The method of claim 6, wherein the semantic database is initialized by at least one of subject-matter experts and users, and then moves into an autonomous mode for updating.

8. The method of claim 6, wherein the materials are mapped in the three-dimensional space and distances between the users and the materials are used to select which materials are used for the information-push and information-pull mechanisms.

9. The method of claim 1, wherein building user profiles comprises building a group user profile, and wherein updating the user profiles comprises updating the group user profile to reflect the modification of the engagement level of the group.

10. The method of claim 1, wherein the modification of the engagement level is measured as any one of a change in a frequency of contribution, a change in a frequency of consumption of information, a change in a complexity level of contribution, a change in a complexity level of information consumed, a change in a frequency of interaction, and a change in a level of interaction.

11. A system, comprising:
a processing unit; and
a non-transitory computer-readable memory communicatively coupled to the processing unit and comprising computer-readable program instructions executable by the processing unit for:
(a) defining a collective mission and a user group to whom the collective mission applies;
(b) building user profiles for users of the user group, each one of the user profiles defining an engagement level of a given user, the engagement level having a plurality of components;
(c) providing the users with tasks in accordance with a corresponding engagement level, the tasks designed to bring about progression of the users towards the collective mission;
(d) monitoring user behavior in response to the tasks and detecting changes in user behavior, the changes indicative of a modification of the engagement level;
(e) updating the user profiles to reflect the modification of the engagement level; and
(f) repeating (c), (d), and (e).

12. The system of claim 11, wherein the plurality of components comprise a thinking component, an action component, and a knowledge component, the thinking component corresponding to a level of analysis of the user, the action component corresponding to a level of interaction of the user within the organization, and the knowledge component corresponding to a level of knowledge of the user with regards to the collective mission.

13. The system of claim 12, wherein the plurality of components each haven levels associated thereto, and the engagement level of each user is mapped in a three dimensional space along a thinking component axis, an action component axis, and a knowledge component axis.

14. The system of claim 13, wherein the program instructions are further executable for mapping the collective mission in the three-dimensional space, measuring a distance between the users and the collective mission, and determining an optimal path for inducing the progression of the users towards the collective mission.

15. The system of claim 13, wherein providing the users with tasks comprises using information-push mechanisms to steer information to the users and using information-pull mechanisms to solicit feedback from the users.

16. The system of claim 15, wherein materials used for the information-push and information-pull mechanisms are stored and retrieved from a semantic database that is updated regularly, and the materials are individually tagged.

17. The system of claim 16, wherein the semantic database is initialized by at least one of subject-matter experts and users, and then moves into an autonomous mode for updating.

18. The system of claim 16, wherein the materials are mapped in the three-dimensional space and distances between the users and the materials are used to select which materials are used for the information-push and information-pull mechanisms.

19. The system of claim 11, wherein building user profiles comprises building a group user profile, and wherein updating the user profiles comprises updating the group user profile to reflect the modification of the engagement level of the group.

20. The system of claim 11, wherein the modification of the engagement level is measured as any one of a change in a frequency of contribution, a change in a frequency of consumption of information, a change in a complexity level of contribution, a change in a complexity level of information consumed, a change in a frequency of interaction, and a change in a level of interaction.
